(19) United States
(12) Patent Application Publication
(10) Pub. No.: US 2004/0174206 A1
(43) Pub. Date: Sep. 9, 2004

(54) Voltage detecting circuit

(76) Inventor: Atsuko Matsumura, Chiba-shi (JP)

Correspondence Address: ADAMS & WILKS, 31st Floor, 50 Broadway, New York, NY, 10004, US

(21) Appl. No.: 10/739,969

(22) Filed: Dec. 18, 2003

(30) Foreign Application Priority Data
Dec. 20, 2002 (JP) 2002-369461

(51) Int. Cl. G05F 1/10; G05F 3/02

(52) U.S. Cl. 327/541

(57) ABSTRACT

In order to solve a problem that during rise of an input voltage Vin, when the input voltage Vin exceeds a level of Vdet−, but does not yet exceed a level of Vdet+, no release signal is outputted, there is provided a voltage detecting circuit which is capable of removing a hysteresis voltage during the rise of the voltage Vin to output a release signal even in a case where the voltage Vin exceeds Vdet−, but does not yet exceed Vdet+.

### BACKGROUND OF THE INVENTION

1. Field of the Invention

The present invention relates to a voltage detecting circuit for detecting a specific voltage, which includes a comparator, a reference voltage circuit, and a voltage dividing circuit. In particular, the invention relates to a voltage detecting circuit capable of adjusting a hysteresis voltage.

2. Related Background Art

As a conventional voltage detecting circuit, a circuit as shown in a circuit diagram of FIG. 6 has been known. That is, the circuit includes a resistance division circuit 1, a reference voltage circuit 2, a comparator 3, and a hysteresis resistance switch 200 to which an output voltage of the comparator 3 is fed back (refer to JP 2000-111589 A (FIG. 4), for example).

FIG. 4 shows functions of terminals of the voltage detecting circuit shown in FIG. 6.

When an input voltage Vin gradually increases to reach a level of Vdet+ which is higher than that of Vdet− by a hysteresis voltage, a level of an output voltage Vout is changed from Low to High to output a release signal. In contrast, when the input voltage Vin gradually drops to reach a level of Vdet−, the level of the output voltage Vout is changed from High to Low to output a detection signal.

Note that, the hysteresis voltage is indispensable to stabilization of the output voltage. The hysteresis resistance switch 200 is turned ON/OFF to change a resistance ratio of the resistance division circuit 1 to thereby adjust the voltage.

Here, assuming that an output voltage of the reference voltage circuit is represented as Vref, and the hysteresis voltage is represented as Vhys, Vdet−, Vdet+, and Vhys are expressed as follows:

Vdet−=((R101+R102+R103)/(R102+R103))×Vref

Vdet+=((R101+R102)/(R102))×Vref

$$\begin{matrix}Vhys = ( Vdet + ) - ( Vdet - ) \\ = ( ( R101 + R103 ) / ( R102 \times ( R102 + R103 ) ) \times Vref > 0\end{matrix}$$

However, in the conventional voltage detecting circuit configured as shown in FIG. 6, there is a problem in that when the input voltage Vin exceeds Vdet− but does not exceed Vdet+ at a rising time of the input voltage Vin, no release signal is outputted.

### SUMMARY OF THE INVENTION

In the light of the foregoing, the present invention has been made with a view to solving the above problems inherent in the prior art and it is, therefore, an object of the present invention to provide a voltage detecting circuit capable of decreasing a hysteresis voltage at a rising time of an input voltage Vin so as to output a release signal even when the input voltage Vin exceeds a level of Vdet− but does not exceed a level of Vdet+.

In order to attain the above-mentioned object, in a voltage detecting circuit according to the present invention, a circuit configuration is adopted in which a level relationship between a voltage obtained by dividing an input voltage Vin, and a reference voltage, which are two input voltages to a comparator at the rising time of the input voltage Vin, is adjusted to enable a hysteresis voltage adjustment.

A voltage detecting circuit according to one aspect of the present invention includes a voltage dividing circuit including a first resistor, a second resistor, and a third resistor connected in series between a first power source and a second power source and outputting a divided voltage value as a potential difference between the first power source and the second power source from an output terminal as a node between the first resistor and the second resistor. Further, the voltage detecting circuit includes: a reference voltage circuit for generating a reference voltage; and a comparator for receiving a signal according to an output from the voltage dividing circuit and an output from the reference voltage circuit and outputting a signal as an output of the voltage detecting circuit. Further, the voltage detecting circuit includes: a switch connected in parallel to the third resistor, between the second resistor and the second power source; and a hysteresis voltage controlling circuit outputs a signal for turning the switch ON when receiving a signal from the comparator that detects low voltage, and outputs a signal for turning the switch OFF when receiving a signal from the comparator that detects high voltage. Further, the hysteresis voltage controlling circuit outputs a signal for turning the switch OFF after a reset state.

Further, in the voltage detecting circuit according to the aspect of the present invention, the output of the voltage dividing circuit is inputted to a non-inverting input terminal of the comparator and the output of the reference voltage circuit is inputted to an inverting input terminal of the comparator. Also, in the voltage detecting circuit, the hysteresis voltage controlling circuit includes: an input terminal to which the output of the comparator is inputted; a reset input terminal to which a reset signal for returning the hysteresis voltage controlling circuit to a reset state is inputted; and an output terminal for outputting a signal for controlling the switch circuit.

An electronic device according to the present invention includes the voltage detecting circuit.

### BRIEF DESCRIPTION OF THE DRAWINGS

In the accompanying drawings:

FIG. 1 is an explanatory circuit diagram showing a voltage detecting circuit according to a first embodiment of the present invention;

FIG. 2 is a circuit diagram showing an example of a hysteresis voltage controlling circuit according to the first embodiment of the present invention;

FIG. 3 is an explanatory circuit diagram showing a voltage detecting circuit according to a second embodiment of the present invention;

FIG. 4 is a graph illustrating an operation of a conventional voltage detecting circuit;

FIG. 5 is a timing chart explaining an operation of the voltage detecting circuit according to the first embodiment of the present invention; and

FIG. 6 is an explanatory circuit diagram showing the conventional voltage detecting circuit.

### DETAILED DESCRIPTION OF THE PREFERRED EMBODIMENTS

Hereinafter, embodiments of the present invention will be described with reference to the accompanying drawings.

### Embodiment

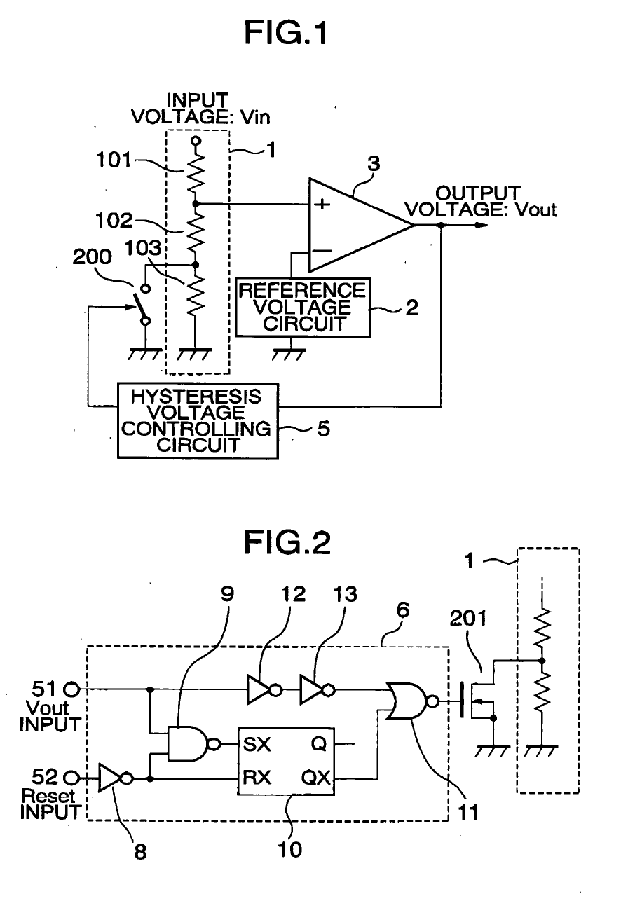

FIG. 1 is a circuit diagram showing a voltage detecting circuit according to a first embodiment of the present invention. In FIG. 1, a hysteresis voltage controlling circuit 5 is inserted between an output terminal of a comparator 3 and a control signal input terminal of a hysteresis resistance switch 200.

The voltage detecting circuit of this embodiment includes a voltage dividing circuit 1 including a first resistor 101, a second resistor 102, and a third resistor 103 connected in series between an input voltage and a ground potential and outputting a voltage value obtained by dividing the input voltage from an output terminal as a node between the first resistor 101 and the second resistor 102. Further, the voltage detecting circuit includes: a reference voltage circuit 7 for generating a reference voltage and outputting the reference voltage; and the comparator 3 for receiving a signal according to an output from the voltage dividing circuit 1 and an output from the reference voltage circuit 7 with delay and outputting a signal as an output of the voltage detecting circuit.

Also, the voltage detecting circuit is constituted of: the switch 200 connected in parallel to the third resistor 103, between the second resistor 102 and the ground potential; and the hysteresis voltage controlling circuit 5 for receiving a signal according to an output from the comparator 3 and outputting a signal for controlling the switch 200.

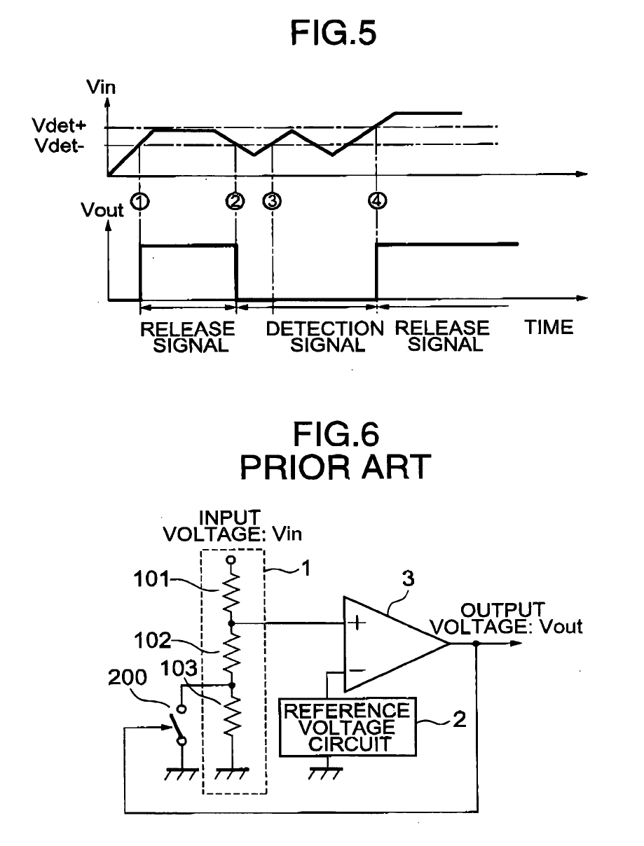

FIG. 5 is a timing chart showing an operation of the voltage detecting circuit shown in FIG. 1. When an input voltage Vin rises to reach a level of Vdet− (time point 1), a level of an output voltage Vout is changed from Low to High to output a release signal. At this time, even if the input voltage Vin does not exceed a level of Vdet+, the release signal is held.

Next, when the input voltage Vin gradually drops to reach the level of Vdet− (time point 2), the level of the output voltage Vout is changed from High to Low to output a detection signal.

Next, even when the input voltage Vin gradually rises to reach the level of Vdet− (time point 3), the input voltage Vin does not reach the level of Vdet+ this time, and therefore, no release signal is outputted in the form of the output voltage Vout. Thus, the level of the output signal Vout is kept Low to hold the detection signal as it is.

Next, when the input voltage Vin rises again to reach the level of Vdet+ (time point 4), the release signal is outputted in the form of the output signal Vout.

Thus, at the rising time of the input voltage Vin, i.e., only when the detection signal is first outputted, the level of Vdet− becomes a release voltage. Then, when the release signal is outputted once, subsequently, the level of Vdet+ becomes the release voltage as in the conventional voltage detecting circuit.

FIG. 2 shows a specific example of the hysteresis voltage controlling circuit 5 and the hysteresis resistance switch 200 shown in FIG. 1. This circuit of FIG. 2 is constituted of a logical circuit 6 using an RXSX flip-flop 10, and an N-channel MOS transistor 201.

The hysteresis voltage controlling circuit 5 includes: a first inverter 8 for receiving the reset signal and outputting a signal; and a NAND circuit 9 to which the output of the comparator 3 and an output of the first inverter Bare inputted. Further, the circuit 5 includes: an RXSX flip-flop 10 having an SX terminal receiving an output of the NAND circuit 9, an RX terminal receiving an output of the first inverter 8, and a QX terminal for outputting an output signal; and a NOR circuit 11 for receiving a signal outputted through inverters 12 and 13 corresponding to the output of the comparator 3 and an output signal from the RXSX flip-flop 10 and outputting a signal to the output terminal. The operation of FIG. 5 can be realized using this circuit.

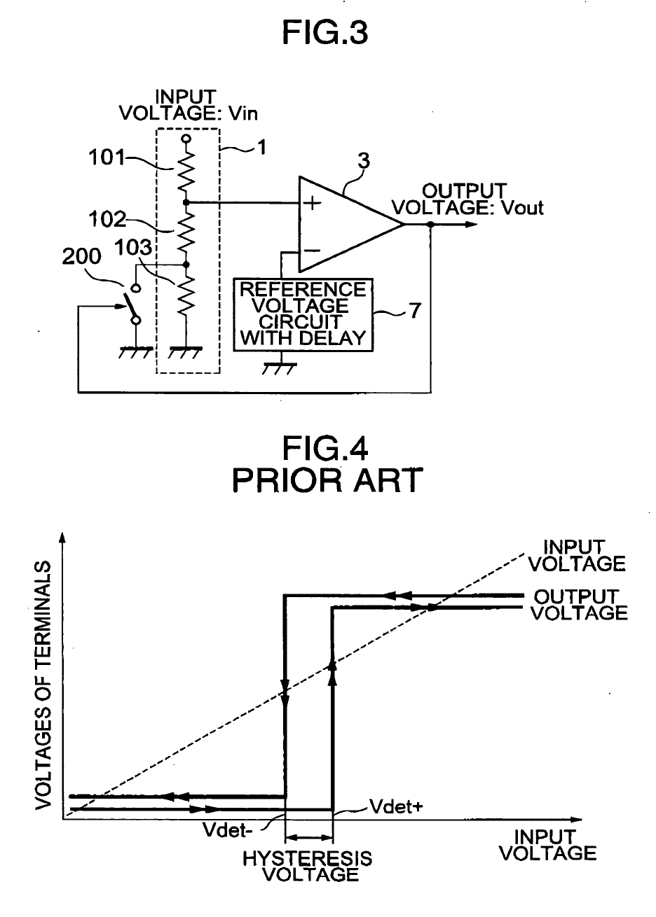

FIG. 3 is a circuit diagram showing an SW regulator controlling circuit according to a second embodiment of the present invention. The voltage detecting circuit includes the voltage dividing circuit 1 including the first resistor 101, the second resistor 102, and the third resistor 103 connected in series between an input voltage and a ground potential and outputting a voltage value obtained by dividing the input voltage from an output terminal as a node between the first resistor 101 and the second resistor 102. Further, the voltage detecting circuit includes: the reference voltage circuit 7 with delay for generating a reference-voltage with a predetermined delay time and outputting the reference voltage; and the comparator 3 for receiving a signal according to an output from the voltage dividing circuit 1 and an output from the reference voltage circuit 7 with delay and outputting a signal as an output of the voltage detecting circuit. Also, the voltage detecting circuit is constituted of a switch connected in parallel to the third resistor, between the second resistor and the second power source and controlled by an inputted signal according to the output of the comparator.

A reference voltage Vref rises later than rise of the input voltage Vin in accordance with an operation of the reference voltage circuit 7 with delay. Thus, at the rising time of the input voltage Vin, i.e., only when the detection signal is first outputted, a level of the release voltage becomes lower than that of Vdet+ to allow the hysteresis voltage to be decreased. After rise of the input voltage Vin, the level of Vdet+ becomes the release voltage as in the conventional voltage detecting circuit.

The electronic device including the voltage detecting circuit can exhibit a higher performance because the voltage can be detected more accurately.

The voltage detecting circuit according to the present invention has an effect in that a hysteresis voltage can be decreased at the rising time of the voltage Vin to output the release signal even if the input voltage Vin exceeds a level of Vdet−, but does not exceed a level of Vdet+.

What is claimed is:

1. A voltage detecting circuit comprising:
a voltage dividing circuit including a first resistor, a second resistor, and a third resistor connected in series between a first power source and a second power source and outputting a divided voltage value as a potential difference between the first power source and the second power source from an output terminal as a node between the first resistor and the second resistor;
a reference voltage circuit for generating a reference voltage;
a comparator for receiving a signal according to an output from the voltage dividing circuit and an output from the reference voltage circuit and outputting a signal as an output of the voltage detecting circuit;
a switch connected in parallel to the third resistor, between the second resistor and the second power source; and
a hysteresis voltage controlling circuit outputs a signal for turning the switch ON when receiving a signal from the comparator that detects low voltage, and outputs a signal for turning the switch OFF when receiving a signal from the comparator that detects high voltage,
wherein the hysteresis voltage controlling circuit outputs a signal for turning the switch OFF after a reset state.

2. A voltage detecting circuit according to claim 1, wherein:
the output of the voltage dividing circuit is inputted to a non-inverting input terminal of the comparator;
the output of the reference voltage circuit is inputted to an inverting input terminal of the comparator; and
the hysteresis voltage controlling circuit includes:
an input terminal to which the output of the comparator is inputted;
a reset input terminal to which a reset signal for returning the hysteresis voltage controlling circuit to a reset state is inputted; and
an output terminal for outputting a signal for controlling the switch circuit.

3. A voltage detecting circuit according to claim 2, wherein:
the hysteresis voltage controlling circuit includes:
a first inverter for receiving the reset signal and outputting a signal;
a NAND circuit to which the output of the comparator and an output of the first inverter are inputted;
an RXSX flip-flop having an SX terminal receiving an output of the NAND circuit, an RX terminal receiving an output of the first inverter, and a QX terminal for outputting an output signal; and
a NOR circuit for receiving a signal according to the output of the comparator and an output signal from the RXSX flip-flop and outputting a signal to the output terminal.

4. A voltage detecting circuit comprising;
a voltage dividing circuit including a first resistor, a second resistor, and a third resistor connected in series between a first power source and a second power source and outputting a divided voltage value as a potential difference between the first power source and the second power source from an output terminal as a node between the first resistor and the second resistor;
a reference voltage circuit for outputting a reference voltage after a predetermined delay time;
a comparator for receiving a signal according to an output from the voltage dividing circuit and an output from the reference voltage circuit and outputting a signal as an output of the voltage detecting circuit; and
a switch connected in parallel to the third resistor, between the second resistor and the second power source and controlled by an inputted signal according to an output of the comparator.

5. A voltage detecting circuit for detecting a specific voltage, comprising:
a comparator;
a reference voltage circuit; and
a voltage dividing circuit,
wherein at a rising time of an input voltage, a hysteresis resistance value is adjusted to eliminate a hysteresis voltage.

6. A voltage detecting circuit for detecting a specific voltage, comprising:
a comparator;
a reference voltage circuit; and
a voltage dividing circuit,
wherein at the rising time of the input voltage, a reference voltage outputted from the reference voltage circuit is allowed to rise with a delay to reduce the hysteresis voltage.

7. An electronic device having the voltage detecting circuit according to claim 4.

8. An electronic device, having the voltage detecting circuit according to claim 1.
